(19) United States
(12) Patent Application Publication
(10) Pub. No.: US 2014/0084676 A1
(43) Pub. Date: Mar. 27, 2014

(54) POSITIVE BIASED PILOT FILTER FOR ELECTRIC VEHICLE SUPPLY EQUIPMENT

(71) Applicant: Scott Berman, Los Angeles, CA (US)

(72) Inventor: Scott Berman, Los Angeles, CA (US)

(73) Assignee: AEROVIRONMENT, INC., Monrovia, CA (US)

(21) Appl. No.: 14/114,724

(22) PCT Filed: Apr. 30, 2012
(86) PCT No.: PCT/US2012/035881

§ 371 Date: Oct. 29, 2013

Related U.S. Application Data
(60) Provisional application No. 61/480,370, filed on Apr. 29, 2011.
(60) Provisional application No. 61/483,051, filed on May 5, 2011.

(51) Int. Cl. B60R 16/03

(52) U.S. Cl. CPC B60R 16/03
USPC 307/9.1; 327/91

(57) ABSTRACT

In one implementation a method is provided for filtering a detected pilot signal. The method includes storing a pilot signal sample in a first in first out memory, sorting the pilot signal samples, and determining an average value of a subgroup of the sorted pilot signal samples. The method further includes controlling application of utility power to an electric vehicle based on the average value of the subgroup.

### CROSS REFERENCE TO RELATED APPLICATION

The present application claims the benefit of the following U.S. Provisional Applications both herein incorporated by reference in their entireties:

U.S. Provisional Application 61/480,370, by Scott Berman, filed Apr. 29, 2011, entitled POSITIVE BIASED PILOT FILTER FOR ELECTRIC VEHICLE SUPPLY EQUIPMENT; and

U.S. Provisional Application 61/483,051, by Scott Berman, filed Apr. 29, 2011, entitled POSITIVE BIASED PILOT FILTER FOR ELECTRIC VEHICLE SUPPLY EQUIPMENT.

The present application is related to PCT Application No. PCT/US12/23487, filed Feb. 1, 2012 by Flack et al., entitled PILOT SIGNAL FILTER, which claims priority of U.S. Provisional Application 61/438,487 filed Feb. 1, 2011, by Flack et al., entitled PILOT SIGNAL FILTER, both herein incorporated by reference in their entireties.

The present application is related to PCT Application PCT/US11/32579 filed Apr. 14, 2011, by Flack, entitled PILOT SIGNAL GENERATION CIRCUIT, herein incorporated by reference in its entirety.

### BACKGROUND

Electric vehicle supply equipment must comply with requisite safety and compliance standards to be deemed fit for public use and commercial sale. In particular, national UL regulations necessitate that all electronic devices pass inspections from nationally certified testing laboratories. These inspections include a conducted noise test in which signal noise is passed throughout the system, which is monitored to ensure that the generated noise is attenuated to a minimum.

The pilot circuit is a high impedance circuit with a +/−12V source and a 1 k ohm resistor in series with a ft line to an electric vehicle. Along the line to the vehicle, the pilot signal line is parallel to the power lines, so any noise on the power lines tends to couple to the pilot signal line. This creates noise on the pilot signal in a range anywhere from a few Hz to GHz.

A conducted and radiated susceptibility test typically includes a broadcast at 80 MHz-1 GHz and wiring inserted noise between 400 KHz-80 MHz. A conventional solution for diminishing noise sufficiently to pass the SAE J1772 standard conducted and radiated susceptibility test is the inclusion of ferrite beads or rings which act as passive low-pass filters to reflect or absorb high-frequency signals. The inclusion of multiple ferrite rings or toroids, however, increases material and manufacturing costs as well as the increases the weight of the product and the resulting shipping costs.

What is needed is a more cost effective means to reduce noise on the pilot signal. Further what is needed is a means that supports and enhances the application of the SAE J-1772 standard for reading the communication level control voltages without noise induced errors.

### SUMMARY

In one implementation a method for filtering a detected pilot signal is provided. The method includes storing a pilot signal sample in a first in first out memory, sorting the pilot signal samples, and determining an average value of a subgroup of the sorted pilot signal samples. The method further includes controlling application of utility power to an electric vehicle based on the average value of the subgroup.

### BRIEF DESCRIPTION OF THE DRAWINGS

The features and advantages of the present invention will be better understood with regard to the following description, appended claims, and accompanying drawings where:

FIG. 1 shows a simplified conceptual schematic of the EVSE pilot signal to vehicle circuit.

FIG. 2 is a simplified timing diagram of the plot signal.

FIG. 3A shows a simplified flow diagram of one possible implementation of a software filter.

FIG. 3B shows a simplified flow diagram of one possible implementation of a circular buffer software filter.

FIG. 4 shows a simplified block diagram of an electric vehicle supply equipment or EVSE.

FIG. 5 shows a circuit diagram of one possible embodiment of the pilot generator and detector of FIG. 4.

### DESCRIPTION

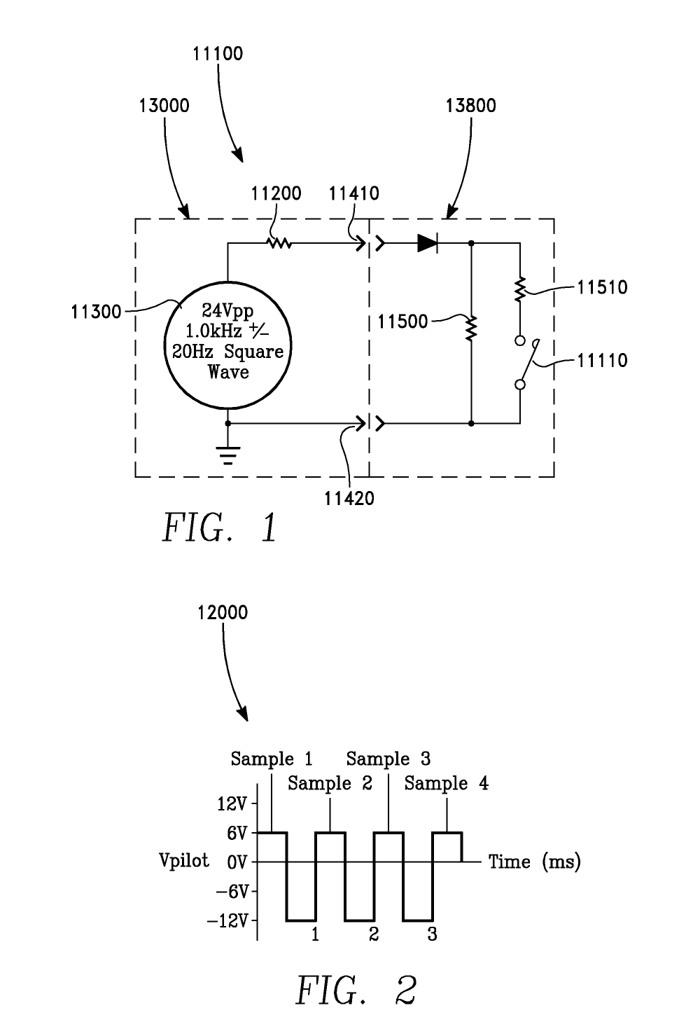

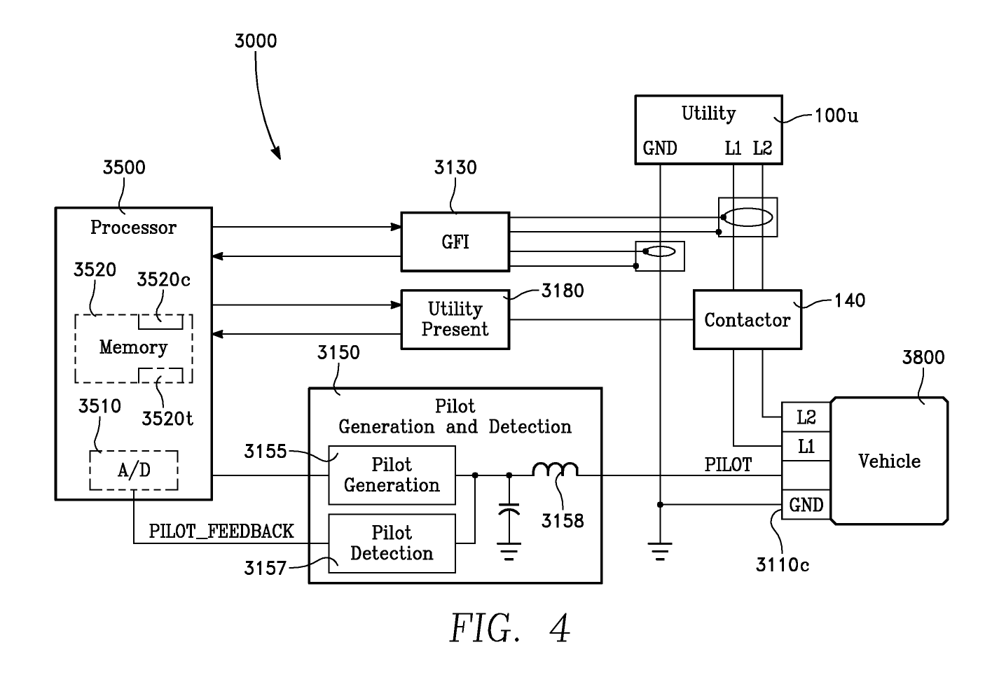

FIG. 1 shows a simplified conceptual schematic of the EVSE pilot signal to vehicle circuit 11100. The EVSE pilot signal is used to determine if the vehicle 13800 is requesting contactor 140 (FIG. 4) closure to supply utility power to the vehicle 13800 for charging. The pilot circuitry does this by supplying a 12V peak (24V peak to peak) square wave with pilot signal generator 11300 to the vehicle 13800 through a 1 k impedance 11200. The EVSE 13000 measures the pilot voltage to determine vehicle 13800 presence, for deciding whether or not to close the utility power contactor 140 (shown in FIG. 4), and thus supply utility power 100u (FIG. 4). The voltage Vpilot across terminals 11410 and 11420 drops from +12V/−12V peak-to-peak, to +9V/−12V peak-to-peak when the vehicle 13800 is connected to the EVSE 11100, which connects resistor 11500 across the terminals 11410 and 11420. The voltage across terminals 11410 and 11420 drops to +6V/−12V peak-to-peak upon the closing of switch 11110. Thus, the voltage of the positive component of the pilot is controlled by the vehicle 13800 by closing switch 11110 to connect resistor 11510, so as to achieve a nominal +6V/−12V Vpilot signal indicating that the EVSE 11100 should close its contactor 140 (FIG. 4).

SAE J1772 specifies that in response to disconnecting the vehicle 13800 cable, the EVSE 13000 shall open the contactor 140 (FIG. 4) within 100 milliseconds. To avoid inadvertent or false contactor opening, in one embodiment, a digital filter is implemented in software by the microcontroller 3500 (FIG. 4) to determine the magnitude of the positive component of the pilot voltage. The filter must do this without exceeding the 100 ms requirement for opening of the contactor.

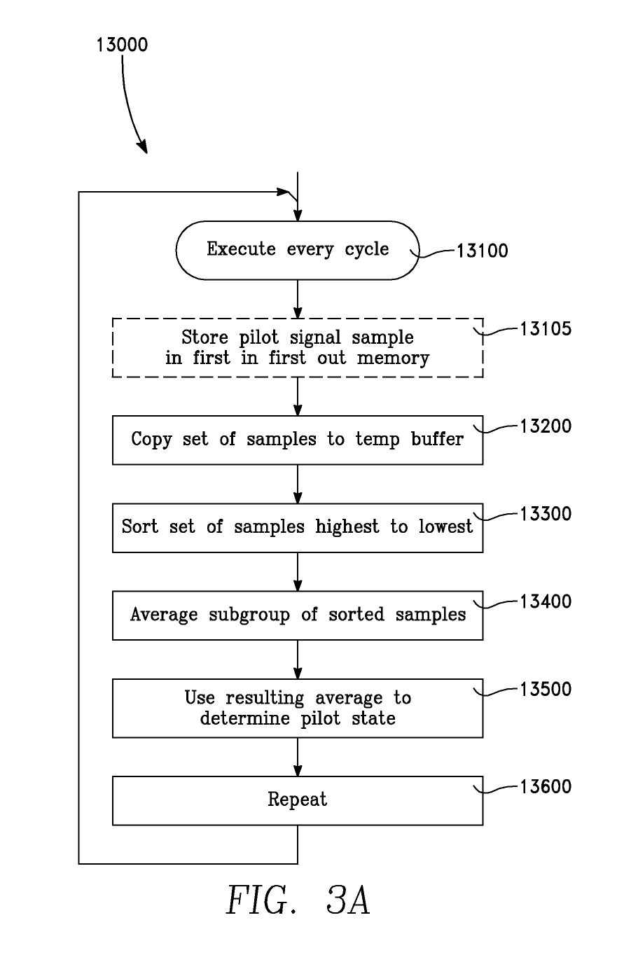

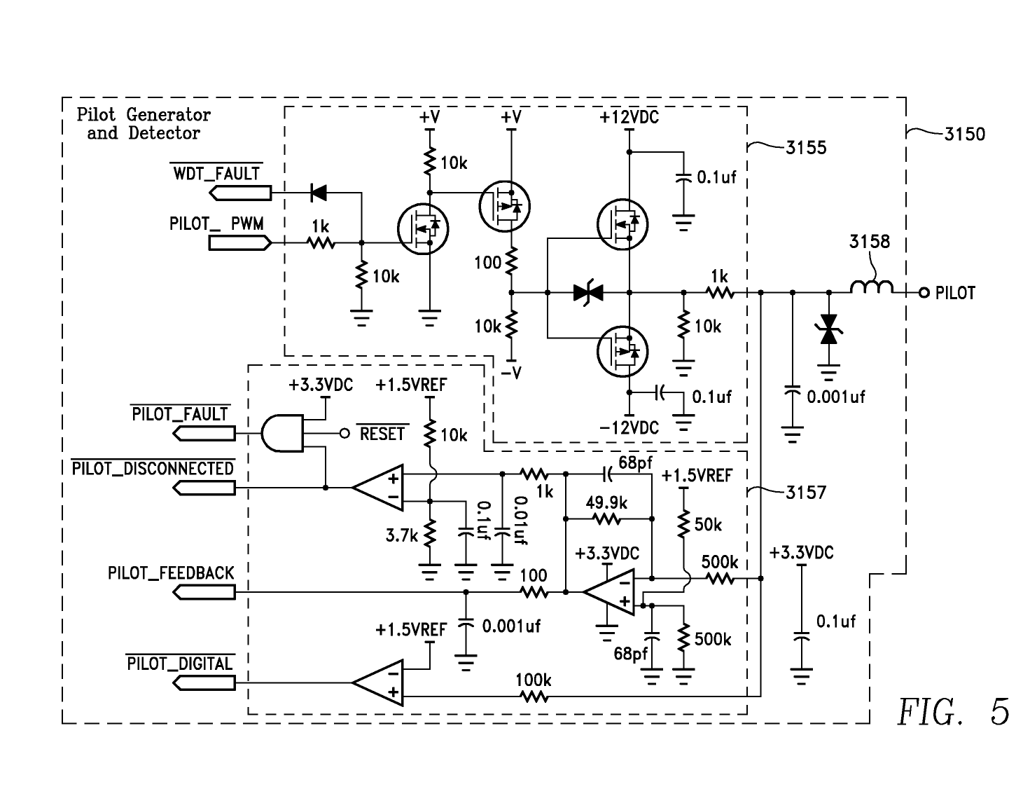

Referring to FIGS. 2-5, the pilot signal voltage PILOT_Feedback signal (FIGS. 4 and 5) is sampled by an A/D converter 3510 (FIG. 4) during the time the microcontroller 3500 (FIG. 4) is outputting the positive component of the pilot signal PILOT_PWM (FIG. 5). As shown the plot 12000 in FIG. 2, one sample is recorded for each pilot pulse. The pilot samples: Sample 1; Sample 2; Sample 3; Sample 4; etc., are stored in a circular buffer 3520c in memory 3520.

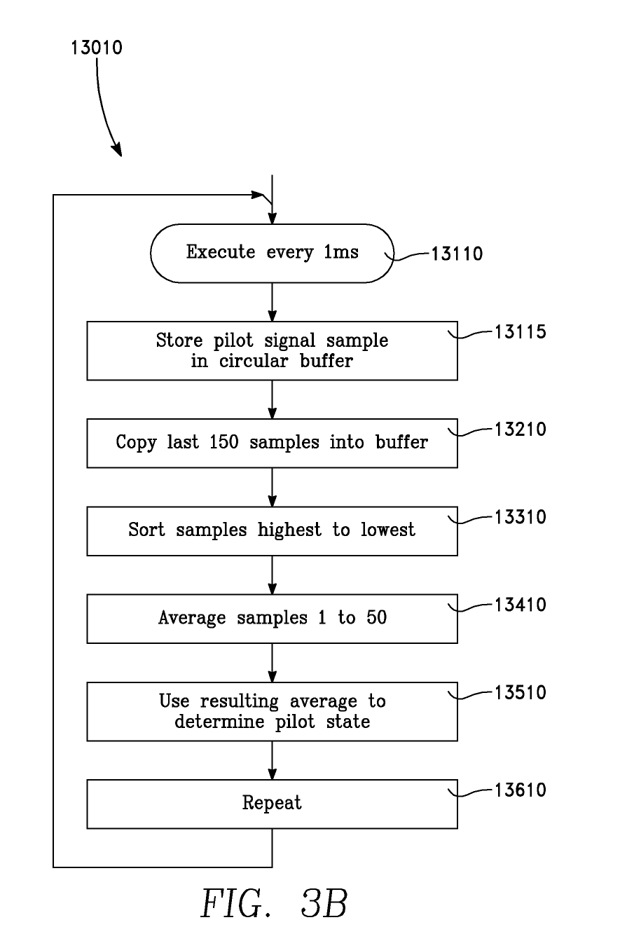

FIG. 3A shows a simplified flow diagram 13000 of one possible implementation of a software filter. In this embodiment, the pilot signal samples are stored in a first in first out memory, such as a circular buffer, at box 13105. A set of samples from the circular buffer are copied to a temporary buffer at box 13200. The set of samples in the temporary buffer are sorted by magnitude at box 13300. A subset of the sorted samples are then averaged shown at block 13400. The resulting average is compared at box 13500 with a threshold limit to determine whether to open/close the contactor supplying utility voltage to the vehicle. This is repeated, box 13100, continuously every pilot signal cycle, so that an average value of the pilot state is continuously determined based on a subset of the values of a preceding group of successive samples.

In one embodiment, the circular buffer 3520c is a 150 sample circular buffer 3520c. After each sample, the circular buffer 3520c is copied to a temporary buffer 3520t and then sorted by magnitude by the microcontroller 3500. The highest or upper 50 samples (˜50 ms) of data is then averaged. The resulting average is compared with the SAE J1772 threshold limits to determine whether to transition, i.e. open or close, the contactor 140 (FIG. 4) that is passing utility power 100u (FIG. 4) to the vehicle 3800 (FIG. 4).

FIG. 3B shows a simplified flow diagram 13010 of one possible implementation of a circular buffer software filter. In this implementation, the pilot samples are stored in a circular buffer, such as 150 sample circular buffer. After each sample, once every pulse cycle, in this case once every 1 millisecond 13110 the samples in the circular buffer are copied to the temporary buffer at box 13210. The samples in the temporary buffer are sorted by magnitude, for example highest to lowest at box 13310. The highest or upper 50 samples (˜50 ms) of data is then averaged shown at block 13410. The resulting average is compared at box 13510 with the SAE J1772 threshold limits to determine whether to transition, i.e. open or close, the contactor 140 (FIG. 4) supplying utility voltage 100u (FIG. 4) to the vehicle 3800 (FIG. 4). This is repeated continuously every pilot signal cycle so that an average value of the pilot state is continuously determined based on a subset of the highest values of a preceding group of successive samples.

By using a circular buffer, the filter implementation 13000 continuously computes an average every cycle, thus insuring that the circuitry can open the contactor 140 (FIG. 4) within 100 milliseconds.

Below is example software programming which can be used to provide processor executable code for processor 3500 for carrying out one implementation of the circular buffer filter.

```
        /**********************************************
*******
        ** Function name: PWM_AverageFiltering
        ** Descriptions: take 33% top value out
of 150 circular samples, then average them.
        ** Calling parameters: Pilot circular buffer
        ** Returned value: Averaged filtered
value
        **
        ***********************************************
******/
        UINT16 PWM_AverageFiltering(void)
        {
            UINT16 i, averageValue;
            UINT32 sumValue;
            int sortBuf[CIRCULAR_BUF_SIZE];
            for (i=0; i<CIRCULAR_BUF_SIZE; i++)
                sortBuf[i] = (int)pilot.raw[i];
            // Sort the data
            qsort(sortBuf, CIRCULAR_BUF_SIZE,
sizeof(int), PWM_SortCompare);
            // Pick the top 33% and average them
            sumValue = 0;
            for (i=0; i<TOP_VALUE_SIZE; i++)
                sumValue += sortBuf[i];
            averageValue =
(UINT16)((float)sumValue/(float)TOP_VALUE_SIZE);
            return averageValue;
        }
```

FIG. 4 shows a simplified block diagram of an electric vehicle supply equipment 3000 or EVSE. FIG. 5 shows a circuit diagram of one possible embodiment of the pilot generator and detector 3150 of FIG. 4. Referring to FIGS. 4 and 5, the EVSE 3000 may include a pilot signal sampler, which in some embodiments may include the pilot signal detector 3157 and the A/D converter 3510. In other embodiments not shown, a standalone A/D converter may sense the PILOT signal at the power delivery output 3110c and provide samples to the processor 3500, if desired.

In the embodiment shown, however, the processor 3500 samples the PILOT_FEEDBACK signal with an A/D converter 3510 and generates samples of the PILOT signal using PILOT_FEEDBACK signal supplied by the pilot signal detector 3157. As the PILOT signal to the vehicle ranges from +12 volts to −12 volts, a pilot detector circuit 3157 within the pilot generation and detection circuit 3150 detects the PILOT signal and reduces it to logic level signals for distribution to the A/D converter 3150. For example, the sensed PILOT signal may be reduced from a range of +12 volts to −12 volts to a range of 0.3 volts to 2.7 volts, correspondingly. The logic level PILOT_FEEDBACK signal is provided to the A/D converter 3150 input of the processor 3500 for storing into memory 3520.

The samples may be stored to a processor readable medium such as an addressable memory 3520, for example RAM. In various embodiments, either one or both of the A/D converter 3510 and the memory 3520 may be external to, or onboard the processor 3500. The processor 3500 of FIG. 4 is programmed to determine a signal level of the PILOT signal output to an electric vehicle 3800 based on the samples of the PILOT_FEEDBACK signal. The amount of samples in a set and the size of the subsets selected, can vary depending on the embodiment. Further, in other embodiments, the circular buffer 3520c may be any type of first in last out type storage device. Additionally, in other embodiments, the temporary buffer 3520t may be any type storage device that can be utilized for capturing and/or while sorting.

Although discussed in FIGS. 3A and 3B as being sampled every cycle, the sample rate is not required to be every cycle. For example, the pilot signal could be sampled every other cycle, or every third, ect., or decimated, ect.

Since the circular buffer filter may be implemented in software, such as with a processor 3500 (FIG. 4), in various implementations, the pilot signal filter software removes the need for additional physical filters such as ferrite rings, which saves on material and installation costs as well as conserves space within the service equipment apparatus.

For example, referring to FIG. 4, the above circular buffer pilot signal filter allowed elimination of 4 toroidal ferrite filters 3158 (approximately 3″ diameter) in the pilot generation and detection circuitry 3150.

In addition, because taking too many readings can slow down the response of the EVSE 3000, the above discussed circular buffer and filtering by averaging only the top one third of the data ensures filter efficacy both in reducing the effects of signal noise, and ensuring that the overall sampling rate provides reasonable response times, so as to provide compliance with the SAE J1772 standard.

In some embodiments not shown, the implementations and embodiments could be implemented in a field programmable gate array or FPGA. For example, a system on a chip could be employed. Moreover, it is possible in some embodiments, that the samples need not be copied to a temporary buffer for sorting. Instead, it is possible, for example, to sweep through and capture the highest value, then second highest, the third highest values, etc., until the desired subset is collected. In some embodiments, it may be preferable to sweep through to collect all the samples of the subset for averaging, prior to the commencement of the next pilot signal cycle. In other embodiments, this may not be necessary and the highest samples could be collected over several cycles.

Further, in some implementations, the modulation rate of the pilot signal is selected to be offset from the 1000 Hz modulation rate so as to reduce the effects of and susceptibility to noise centered at 1000 Hz. Thus, in some implementations, the modulation rate of the pilot signal may be selected to be a value other than 1000 Hz, but within the 980-1020 Hz range allowed by the SAE J1772 standard. For example, a modulation rate of 1015 Hz may be selected so that the effects of introduced noise centered at 1000 Hz are reduced. In some embodiments, the modulation rate may be at +/−10% to 15% away from the center modulation rate. In other embodiments, it may be selected to be anywhere from +/−1% to +/−19%, so long the signal stays within the allowed range of the applicable standard.

In this implementation, the pilot signal modulation should be selected as far away from the center modulation as possible, but within the given precision/tolerance of the modulation circuitry, so as to ensure that the modulation will remain within the allowable range.

The offset pilot signal further improves the results of the two-tiered signal filter discussed herein to provide improved detection accuracy of pilot signals having 150 KHz to 1 GHz induced noise at a 1 kHz rate. The offset pilot signal may be used with or without the two-tiered signal filter discussed herein, or with other software and/or hardware filtering.

It is worthy to note that any reference to “one embodiment” or “an embodiment” means that a particular feature, structure, or characteristic described in connection with the embodiment may be included in an embodiment, if desired. The appearances of the phrase “in one embodiment” in various places in the specification are not necessarily all referring to the same embodiment.

The illustrations and examples provided herein are for explanatory purposes and are not intended to limit the scope of the appended claims. This disclosure is to be considered an exemplification of the principles of the invention and is not intended to limit the spirit and scope of the invention and/or claims of the embodiment illustrated.

Those skilled in the art will make modifications to the invention for particular applications of the invention.

The discussion included in this patent is intended to serve as a basic description. The reader should be aware that the specific discussion may not explicitly describe all embodiments possible and alternatives are implicit. Also, this discussion may not fully explain the generic nature of the invention and may not explicitly show how each feature or element can actually be representative or equivalent elements. Again, these are implicitly included in this disclosure. Where the invention is described in device-oriented terminology, each element of the device implicitly performs a function. It should also be understood that a variety of changes may be made without departing from the essence of the invention. Such changes are also implicitly included in the description. These changes still fall within the scope of this invention.

Further, each of the various elements of the invention and claims may also be achieved in a variety of manners. This disclosure should be understood to encompass each such variation, be it a variation of any apparatus embodiment, a method embodiment, or even merely a variation of any element of these. Particularly, it should be understood that as the disclosure relates to elements of the invention, the words for each element may be expressed by equivalent apparatus terms even if only the function or result is the same. Such equivalent, broader, or even more generic terms should be considered to be encompassed in the description of each element or action. Such terms can be substituted where desired to make explicit the implicitly broad coverage to which this invention is entitled. It should be understood that all actions may be expressed as a means for taking that action or as an element which causes that action. Similarly, each physical element disclosed should be understood to encompass a disclosure of the action which that physical element facilitates. Such changes and alternative terms are to be understood to be explicitly included in the description.

Having described this invention in connection with a number of embodiments, modification will now certainly suggest itself to those skilled in the art. The example embodiments herein are not intended to be limiting, various configurations and combinations of features are possible. As such, the invention is not limited to the disclosed embodiments, except as required by the appended claims.

1. In an electric vehicle supply equipment comprising a pilot signal, a method for reducing noise on a pilot signal output to determine a value of the pilot signal output to an electric vehicle, the method comprising:
sampling the pilot signal;
storing a set of samples in a circular buffer;
copying the set of samples to a temporary buffer;
sorting the samples in the temporary buffer;
selecting a subset of the sorted samples;
averaging the samples of the subset; and
comparing the average value of the samples of the subset to a threshold value determine a state of the pilot signal.

2. The method of claim 1, further comprising controlling application of utility power to the electric vehicle based on the comparison of the average value to a threshold value.

3. The method of claim 1, wherein selecting the subset comprises selecting the samples with the highest values, and further comprising repeating continuously the steps of sampling, storing, copying, sorting, selecting, averaging, and comparing during every pilot signal cycle so that an average value of the pilot state is continuously determined based on the subset of the highest values of a preceding set of successive samples.

4. The method of claim 1, comprising continuously computing an average every cycle of the pilot signal.

5. The method of claim 1, wherein a rate of sampling is every cycle of the pilot signal.

6. The method of claim 1, wherein a rate of sampling is less than every cycle of the pilot signal.

7. The method of claim 1, wherein storing the pilot signal in the circular buffer comprises storing 150 samples, and wherein selecting the subset of the sorted samples comprises selecting 50 highest values samples.

8. In electric vehicle supply equipment comprising a pilot signal, a method for determining the state of the pilot signal, the method comprising:
detecting a pilot signal value;
sampling the detected pilot signal;
storing the pilot signal samples in a memory;
sorting the pilot signal samples; and
determining an average value from a subgroup of the sorted pilot signal samples;
comparing the average value to a threshold value; and
controlling application of utility power to the electric vehicle based on the comparison the average value to a threshold value.

9. The method of claim 8, wherein storing comprises storing to a first in first out buffer.

10. The method of claim 9, wherein storing the pilot signal samples in a memory further comprises copying a set of samples from the first in first out memory into a temporary buffer, and wherein sorting comprises sorting the pilot signal samples comprises sorting the pilot signal samples in the temporary buffer.

11. The method of claim 10, wherein sorting comprising sorting from highest to lowest, and wherein determining an average value of a subgroup of the pilot signal samples comprises determining the average value of a subgroup of highest values.

12. The method of claim 11, wherein determining an average value of a subgroup of the pilot signal samples comprises determining the average value of one third of the sorted the pilot signal samples in the temporary buffer.

13. The method of claim 11, wherein determining an average value of a subgroup of the pilot signal samples comprises determining the average value of one third of the sorted the pilot signal samples in the temporary buffer wherein sorting comprises sorting from highest to lowest, and wherein determining an average value of a subgroup of the pilot signal samples comprises determining the average value of a subgroup of the highest values

14. The method of claim 9, wherein storing comprises storing to a circular buffer.

15. The method of claim 14, wherein storing the pilot signal samples in a memory further comprises copying a set of samples from the circular buffer into a temporary buffer.

16. The method of claim 15, wherein sorting comprises sorting the set of samples in the temporary buffer.

17. The method of claim 16, wherein sorting comprises sorting from highest to lowest.

18. The method of claim 17, wherein determining the average value of the subgroup of the sorted pilot signal samples comprises determining an average value of a subset of the highest values.

19. The method of claim 18, wherein selecting the subset of the sorted samples comprises selecting a subset of highest values of the sorted pilot signal samples in the temporary buffer.

20. In an electric vehicle supply equipment comprising a pilot signal, a method for filtering a detected pilot signal, the method comprising:
storing a pilot signal sample in a first in first out memory;
sorting the pilot signal samples;
determining an average value of a subgroup of the sorted pilot signal samples; and
controlling application of utility power to the electric vehicle based on the average value of the subgroup.

21.-25. (canceled)
